(19) United States
(12) Patent Application Publication
(10) Pub. No.: US 2005/0161546 A1
(43) Pub. Date: Jul. 28, 2005

(54) Side acting drive shaft engagement for a data cartridge

(75) Inventor: Christopher J. Zwettler, Lake Elmo, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/763,748

(22) Filed: Jan. 23, 2004

(51) Int. Cl. G11B 23/087

(52) U.S. Cl. 242/342

(57) ABSTRACT

A drive and cartridge combination (10) includes a cartridge (20) for insertion into a drive (100). A driven roller (36) is rotatably mounted in the cartridge (20). A driven member (39) has a drive member capturing member (39d, 39e). The drive member (110) is moveable in a second direction by the driven member (39) when the cartridge (20) is inserted in a first direction into the drive (100).

### BACKGROUND OF THE INVENTION

1. Field of the Invention

This invention relates generally to belt driven data cartridges, and more particularly to a data cartridge having a side acting drive shaft engagement.

2. Description of the Prior Art

Tape data cartridges have been used for decades in the computer, audio and visual fields. The cartridges themselves come in a large variety of sizes and types. Data storage tape cartridges are available in either a single or dual reel type cartridge. One example of a successful belt-driven data cartridge is shown in U.S. Pat. No. 3,692,255 to von Behren. In that patent, a tape cartridge has tape wound convolutedly in opposite directions around hubs and guide pins to guide the tape past the tape drive read/write head. An elastic belt wraps around the tape packs and the hubs, as well as around the corner rollers and a drive roller. The belt is moved by a drive through a frictional rotation of a drive puck by a motor. All current belted data cartridges rely on frictional rotation. The drive roller associated with the data cartridge is engaged by a drive puck which is constructed from a rubber or rubber-like material. The rubber drive puck is acceptable in many instances and provides for a suitable method of driving the cartridge. However, there are speed and power losses present because of the rubber interface.

The belt-driven tape cartridge is highly viable and relatively inexpensive, but may present certain tape drive registration issues, as well as power and speed losses during use due to the rubber-coated drive puck or capstan.

Data tape storage cartridges are important tools used to maintain vast amounts of information. The present invention addresses the issues relating to the prior art tape cartridges with respect to issues raised by the rubber driven drive system.

### SUMMARY OF THE INVENTION

In one embodiment, the invention is a data storage cartridge for use in a drive. The drive has a drive member moveable in a first direction by contact with the cartridge. The cartridge includes a housing having a driven roller opening. A driven roller is rotatably mounted in the housing, the driven roller having an outer surface that engages a drive belt which in turn winds the tape. A driven member is operatively connected to the driven roller. The driven member has a drive member engagement surface, whereby insertion of the cartridge in the drive in a second direction generally perpendicular to the first direction, moves the drive member in a first direction. The driven member has a drive member capturing member, wherein the drive member is coupled to the driven member, thereby allowing rotational movement of the drive member to be transferred to the driven roller.

In another embodiment, the invention is a data storage cartridge and drive combination. The combination includes a data storage cartridge and a drive adapted and configured to receive the data storage cartridge. The drive has a drive member moveable in a first direction by contact with the cartridge. A motor is operatively connected to the drive member for rotating the drive member. The data storage cartridge further includes a housing having a driven roller opening. A driven roller is rotatably mounted in the housing, the driven roller having an outer surface that engages a drive belt which in turn winds the tape. A driven member is operatively connected to the driven roller. The driven member has a drive member engagement surface, whereby insertion of the cartridge in the drive in a second direction generally perpendicular to the first direction, moves the drive member in a first direction. The driven member has a drive member capturing member, wherein the drive member is coupled to the driven member, thereby allowing rotational movement of the drive member to be transferred to the driven roller.

In another embodiment, the invention is a method of engaging a data storage cartridge into a drive, the drive having a drive member moveable between a first position and a second position. The method includes inserting the cartridge into the drive in a first direction. Moving the drive member its first position to its second position by movement of the cartridge in the first direction, movement from the first position to the second position generally perpendicular to the first direction. The drive member is moved back towards its first position when the cartridge is fully inserted and the drive member is engaged to a driven member on the cartridge, whereby rotational movement of the drive member is transferred to the driven member.

### BRIEF DESCRIPTION OF THE DRAWINGS

FIG. 1 is a perspective view of the drive and cartridge combination of the present invention;

FIG. 2 is an exploded perspective view of the drive and cartridge combination shown in FIG. 1;

FIG. 3 is a perspective view of the cartridge shown in FIG. 1;

FIG. 4 is a cross-sectional view of the cartridge shown in FIG. 1, taken generally along the lines 4-4;

FIG. 5 is a perspective view of a portion of the combination shown in FIG. 1;

FIG. 5a is a front elevational view of the combination shown in FIG. 5;

FIG. 5b is a side elevational view of the combination shown in FIG. 5;

FIG. 6 is an enlarged perspective view of a portion of the combination shown in FIG. 2;

FIG. 7 is a perspective view of the combination shown in FIG. 2, viewed from below; and

FIG. 8 is an enlarged perspective view of a portion of the combination shown in FIG. 7.

### DETAILED DESCRIPTION OF THE PREFERRED EMBODIMENT

Referring to the drawings, wherein like numerals represent like parts throughout the several views, there is generally disclosed at 10 a drive and cartridge combination. The combination 10 includes a cartridge 20 and a drive 100. The cartridge 20 includes a housing 21 that may take on any suitable form. The housing 21 is sized and configured to conform to the drive 100. A top 22, bottom 23, first side 24, second side 25, front 26 and back 27 are all operatively connected by means well known in the art to form a generally rectangular shaped housing 11. The housing 21 has a media access opening 28. A pivoting door 29 is positioned over the media access opening 28, when the cartridge 20 is not in the drive 100.

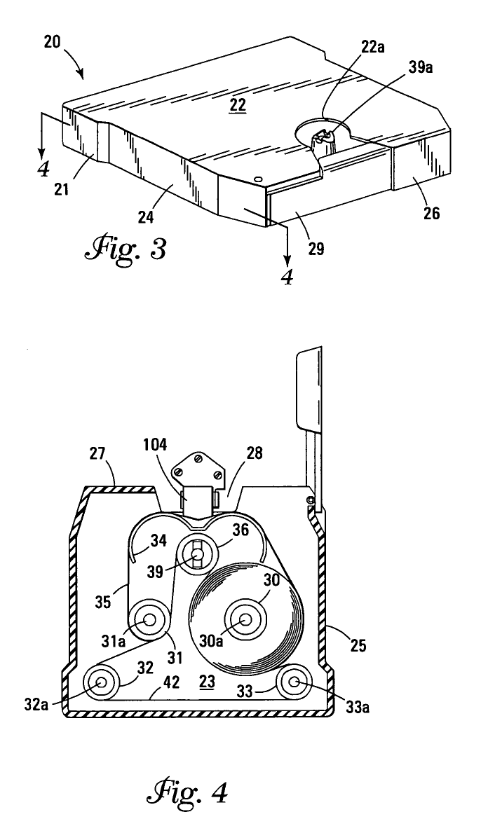

Referring now to FIG. 4 showing the inside of the housing 21, there are rotatably mounted first and second hubs 30, 31 which are suitably mounted for rotation of shafts or pins 30a, 31a, respectively. Tape 35 is wound around the hubs 30, 31 and the tape 35 passes over a tape guide 34. The tape 35 passes proximate a window or opening formed in the housing 21 to allow for access for a read/write head 104. The tape 35 is driven around the hubs 30, 31 by a belt 42. The belt 42 is positioned around idler roller 32, idler roller 33 and driven roller 36. The idler rollers 32, 33 are suitably mounted for rotation by means well known in the art such as by being mounted on shafts 32a, 33a. Such a construction of a cartridge is well known in the art and any other suitable cartridge design may be utilized. The driven roller 36 is unique and will be described in more detail hereinafter.

A driven roller 36 is rotatably mounted on the bottom 23 by any suitable means, well known in the art. One such method would be to mount the driven roller 36 on a shaft 37 that extends into an elongate bore 38 formed in the driven roller 36. An opening 22a is formed in the top 22. The driven roller 36 is mounted underneath the opening 22a to provide access to the driven roller 36, as will be described more fully hereafter. The driven roller 36 has a generally cylindrical shaped outer surface that includes a winding surface 36a that comes in contact with the belt 42 which in turn winds the tape 35. A driven member 39 is operatively connected to the base 36b and extends above the rim 36c of the driven roller 36. The driven member 39, which is also cylindrical, has an upper end 39a. The upper end includes first and second angled surfaces 39b, 39c that are opposite each other. The angled surfaces 39b, 39c, by being on opposite sides of a diameter of the driven member 39 provide for a surface to properly seat and allow for engagement of a portion of the drive, as will be described more fully hereafter, irrespective of the position that the driven member 39 is in when positioned in the cartridge 20. Two generally U-shaped openings 39d, 39e are formed 180 degrees from each other and are also on opposite sides of the upper end 39a. The U-shaped openings 39d, 39e are sized and configured to receive a drive member 120 as will be described more fully hereafter. The U-shaped openings 39d, 39e form a drive member engagement surface for the drive member 120 of the drive 100.

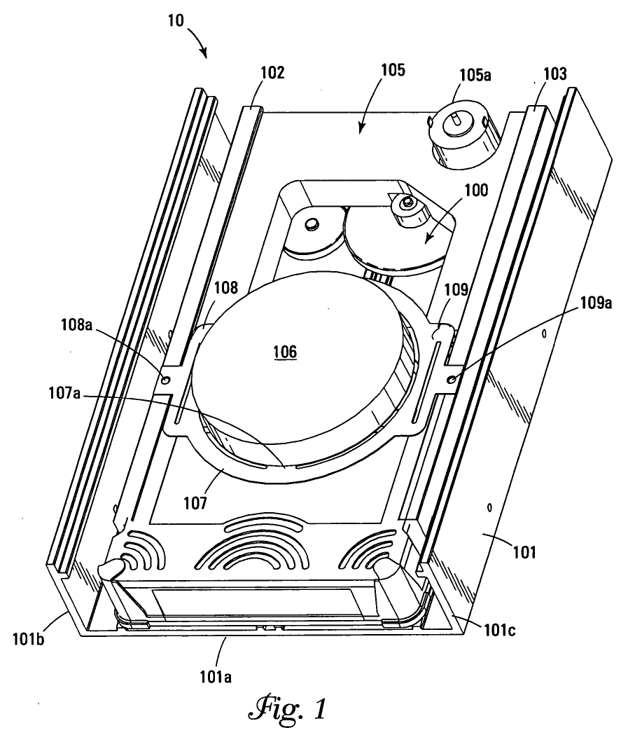

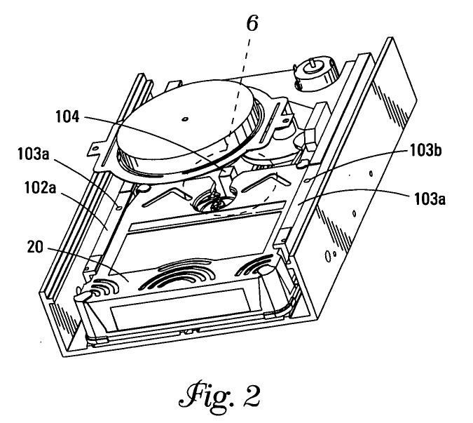

The drive 100 is adapted and configured to receive the cartridge 20. The drive 100 has a generally U-shaped housing 101 having a bottom 101a operatively connected to two sides 101b, 101c. A pair of side rails 102, 103 are operatively connected to the bottom 101a by means well known in the art. The side rails 102, 103 have inward projecting top members 102a, 103a. The side rails 102, 103 and the bottom 101a define a cavity that is sized and configured to receive the cartridge 20. A read/write head 104 is operatively connected to the drive 100 by means well known in the art. Further, a cartridge moving mechanism 105, including a motor 105a, is operatively connected to the drive 100 and is utilized to pull the cartridge 20 into the drive 100. Such a mechanism is well known in the art. The drive 100, described thus far, is well known in the art. The drive 100 also includes a drive motor 106. The motor 106 is mounted to the drive 100 by a spring 107. The spring 107 has a generally circular shape and is generally planar. The spring 107 is connected to the base of the motor 106 at two places. The first is the attachment member 107a and the second is a similar attachment area (not shown) 180 degrees from the attachment area 107a as shown in FIG. 1. The spring 107 has two protrusions 108, 109 that each have a mounting hole 108a, 109a formed therein. Threaded openings 102b, 103b are formed in the side rails. Bolts or other suitable methods may be utilized to secure the spring 107 to the drive 100 through the openings 108a, 109a and 102b, 103b. The spring 107 should have enough deflection to allow the drive member 110 to clear the driven member 39. The spring 107 should also have sufficient force or load, with the cartridge fully inserted, to keep the protrusion 110a of the drive member 110 seated in the U-shaped surface 39e.

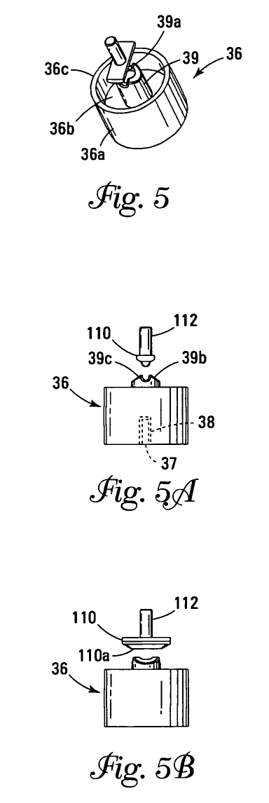

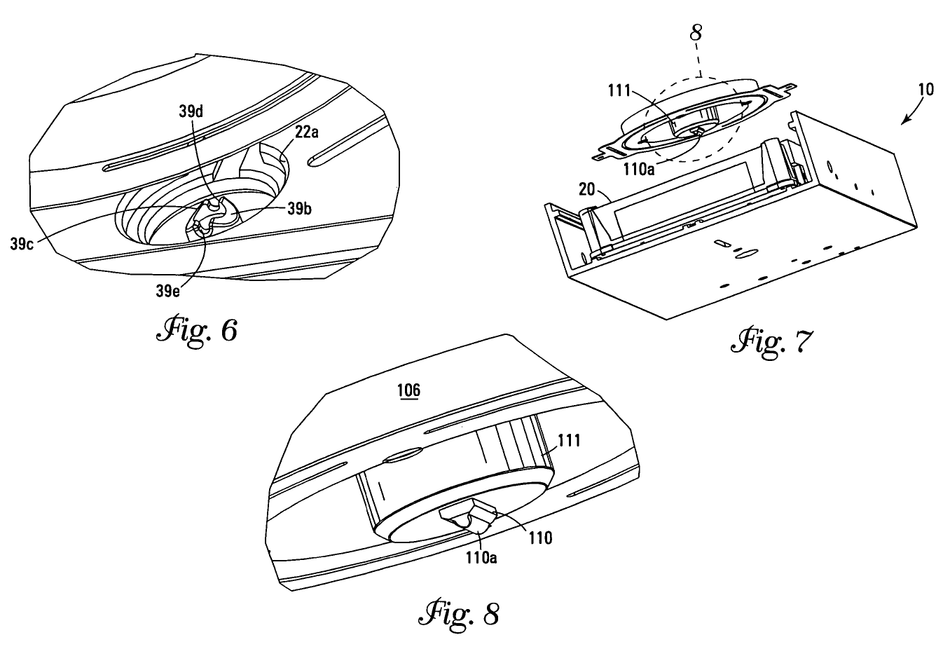

As best seen in FIG. 8, the drive motor 106 includes a drive member 110 that is operatively connected to the drive motor shaft 112. Also shown is a cover 111. As viewed in FIGS. 5a, 5b, the cover 111 has been removed for clarity. The drive motor shaft 112 is rotated by the motor 106. The drive member 110 has a protrusion 110a that is sized and configured to fit within the slot defined by the U-shaped openings 39d, 39e. The drive member 110 is positioned over the opening 22a, when the cartridge 20 is in the loaded position in the drive 100.

Referring now to FIG. 3, it can be seen that the top 22 has an opening 22a that is positioned over the driven member 39. The upper end 39a of the driven member 39 does not extend above the top surface of the top 22. The driven member 39 could extend above the top 22, but does not need to since the opening 22a extends to the front 26 to provide for clearance for the drive member 110, as will be discussed more fully hereafter.

In operation, the cartridge 20 is inserted into the drive 10. The cartridge moving mechanism 105 then operates, by means well known in the art, to pull the cartridge 20 into the drive 100. As the cartridge 20 is being pulled into the drive 100, the drive member 110, and specifically the protrusion 110a, contacts either surface 39b or 39c depending upon the orientation of the driven member 39. The spring 107 has enough deflection to allow the driver 110 to be deflected upward to clear the drive member 110. Then, as the cartridge continues further into the drive 100, the force of the spring 107 is sufficient to move the drive member back toward its first position to seat the protrusion 110a into the U-shaped surface 39e. Then, when the drive motor 106 is activated, the driven member 110 is rotated and this rotational movement is transferred via the protrusion 110a being seated in the U-shaped surface 39e, thereby causing rotation of the driven member 39 and thereby the driven roller 36, which is operatively connected to the driven member 39. This rotational force allows for the winding of the tape 35 on the hubs 30, 31, depending upon the rotation of the driven member 110. As previously indicated, the driven member 39 does not extend above the top 22. This is because the opening 22a extends to the front 26, thereby allowing clearance for the drive member 110 to enter the cartridge 20 below the top 22. If the opening 22a did not extend to the front, the drive member 110 would have to enter the cartridge from above the top 22, which in turn means that the driven member 39 could extend above the top 22. While this is possible, it is preferred to have the opening 22a extend to the front 26 so as not to have the driven member 39 extend beyond the top 22. However, it is also understood that other members could be utilized to cause the upward deflection of the spring 107 and therefore the drive member 110. For instance, the front 26 could be used.

It is understood that the foregoing is one description of one embodiment of the drive 100. It is understood that other embodiments may also be used and still be within the scope of the present invention. For instance, rather than having the motor mounted on the spring 107, the motor could be fixed relative to the drive 100. Then, it would be necessary for the motor to transfer its rotational force to another member that would be mounted on a spring. This other member would then come in contact with the driven member 39. In the preferred embodiment, as described in the Figures, the drive member is carried by the motor, and therefore both the motor and the drive member move with the deflection of the spring 107. However, in the other embodiment, just described, the drive member is carried by a spring and moved in a direction perpendicular to the movement of the cartridge into the drive, and it is not necessary that the motor itself be moved.

In either embodiment, it can be seen that the drive member is moveable in a first direction by contact with the cartridge and this first direction is generally perpendicular to a second direction, which is the direction that the cartridge is inserted into the drive.

1. A data storage cartridge having tape driven by a drive belt for use in a drive, the drive having a drive member movable in a first direction by contact with the cartridge, the cartridge comprising:
a) a housing having a driven roller opening;
b) a driven roller rotatably mounted in the housing, the driven roller having an outer surface for engaging a drive belt which in turn winds the tape;
c) a driven member operatively connected to the driven roller, the driven member having a drive member engagement surface, whereby insertion of the cartridge in the drive in a second direction generally perpendicular to the first direction, moves the drive member in the first direction; and
d) the driven member having a drive member capturing member, wherein the drive member is coupled to the driven member, thereby allowing rotational movement of the drive member to be transferred to the driven roller.

2. The data storage cartridge of claim 1, the driven member further comprising:
a) a cylindrical member having a first end operatively connected to a base of the driven roller and a second end;
b) the drive member engagement surface proximate the second end, the drive member engagement surface being a first angled surface and a second angled surface opposite the first angled surface; and
c) the second end defining a slot and forming the drive member capturing member.

3. The data storage cartridge of claim 2, the housing further comprising a top surface and a front, the driven roller opening is over the driven member.

4. The data storage cartridge of claim 3, wherein the driven roller opening extends to the front.

5. A data storage cartridge having tape driven by a drive belt and drive combination, comprising:
a) a data storage cartridge;
b) a drive adapted and configured to receive the data storage cartridge;
c) the drive having a drive member moveable in a first direction by contact with the cartridge;
d) a motor operatively connected to the drive member for rotating the drive member; and
e) the data storage cartridge further comprising:
i) a housing having a driven roller opening;
ii) a driven roller rotatably mounted in the housing, the driven roller having an outer surface for engaging a drive belt which in turn winds the tape;
iii) a driven member operatively connected to the driven roller, the driven member having a drive member engagement surface, whereby insertion of the cartridge in the drive in a second direction generally perpendicular to the first direction, moves the drive member in the first direction; and
iv) the driven member having a drive member capturing member, wherein the drive member is coupled to the driven member, thereby allowing rotational movement of the drive member to be transferred to the driven roller.

6. The combination of claim 5, further comprising the motor operatively connected to a spring, the spring operatively connected to the drive, and the motor positioned above the driven roller opening, the drive member connected to the motor, wherein the drive member is moveable between a first position and a second position.

7. The combination of claim 6, wherein the motor is moveable between the first position and the second position.

8. The combination of claim 7, the driven member further comprising:
a) a cylindrical member having a first end operatively connected to a base of the driven roller and a second end;
b) the driven member engagement surface proximate the second end, the drive member engagement surface being a first angled surface and a second angled surface opposite the first angled surface; and
c) the second end defining a slot and forming the drive member capturing member.

9. The combination of claim 5, the drive member adapted and configured to be positioned in the slot of the driven member, whereby the driven member is coupled to the drive member.

10. The combination of claim 9, the housing further comprising a top surface and a front, the driven roller opening is over the driven member.

11. The combination of claim 10, wherein the driven roller opening extends to the front.

12. A method of engaging a data storage cartridge into a drive, the drive having a drive member moveable between a first position and a second position, the method comprising:
a) inserting the cartridge into the drive in a first direction;
b) moving the drive member from its first position to its second position by movement of the cartridge in the first direction movement from the first position to the second position generally perpendicular to the first direction;
c) moving the drive member back towards its first position when the cartridge is fully inserted; and
d) engaging the drive member to a driven member on the cartridge, whereby rotational movement of the drive member is transferred to the driven member.
